(19) United States
(12) Patent Application Publication
(10) Pub. No.: US 2024/0140133 A1
(43) Pub. Date: May 2, 2024

(54) HIGH VOLUME BRANDING SYSTEM

(71) Applicant: T&T CONSULTING AND ENGINEERING, INC., East Dundee, IL (US)

(72) Inventors: Tomas TASSY, East Dundee, IL (US); Alex KURDYDYK, East Dundee, IL (US)

(21) Appl. No.: 18/385,246

(22) Filed: Oct. 30, 2023

Related U.S. Application Data
(60) Provisional application No. 63/420,325, filed on Oct. 28, 2022.

(51) Int. Cl. B44B 7/00

(52) U.S. Cl. CPC B44B 7/005; B44B 2700/08

(57) ABSTRACT

The present disclosure is directed to a high volume branding system for branding baked goods with a desired indicia. The system includes a branding conveyor for receiving the baked goods in the pans and conveying the pans downstream. The system also includes a branding station positioned above the branding conveyor. The branding station includes a shuttle that is provided with a branding press. The shuttle is configured to travel downstream with the branding conveyor in a first direction and upstream in a second direction. The shuttle is configured to align a branding press with at least one of the pans on the branding conveyor while the pan is moving downstream with the branding conveyor. The branding press includes a branding plate that is heated and lowered with the branding press onto the baked goods in the pan while the shuttle is moving downstream along with the pan and branding conveyor to brand indicia onto the baked goods. When the indicia is branded onto the baked goods, the branding press and branding plate are raised and the shuttle is moved in the second direction to align the branding press with another one of the pans on the branding conveyor.

### PRIORITY CLAIM

This application claims priority under 35 U.S.C. § 119(e) to U.S. Provisional Application Ser. No. 63/420325, filed Oct. 28, 2022, which is expressly incorporated herein by reference in its entirety.

### FIELD OF THE DISCLOSURE

The present disclosure relates generally to baking equipment, and more specifically to baking equipment used in the commercial baking industry.

### BACKGROUND

The baking industry, specifically the commercial baking industry, produces numerous baked goods such as hamburger buns, hot dog buns, pizza crust, and pita bread, among other items. Adding designs, logos, or wording to the baked goods can be accomplished by printing or branding the baked goods. Such operations take time to accomplish, slowing down the overall production of the baking process. This adds unnecessary time, cost, and complexity to the baked goods. There is a need for a high volume branding system that will allow for the desired branding of baked goods without slowing down the overall commercial baking process to reduce the overall cost of the branded baked goods.

### SUMMARY

The present disclosure may comprise one or more of the following features and combinations thereof.

In illustrative embodiments, the present disclosure is directed to a high speed branding system for branding logos, words, and symbol onto baked goods. The branding system includes a series of conveyors that convey and align baking pans containing unbranded baked goods that are to be branded. The system also includes four branding presses that are part of a branding shuttle that is positioned above baked goods that are traveling on a branding conveyor beneath the branding presses.

In illustrative embodiments, the branding presses are shuttled upstream and downstream along the branding conveyor to align branding press heads with baking pans positioned beneath. The branding presses include servo motors that are configured to drive branding press heads downward so that the branding press heads make contact with the baked goods to be branded. Heaters in the branding press heads heat the branding press heads so that images, words, or logos can be burned/imprinted onto the baked goods. The branding shuttle is designed to move branding press heads downstream in sync with the baking pans positioned below and traveling on the branding conveyor for a certain dwell time so that the images can be properly imprinted onto the bakery goods. Once the dwell time is completed, the branding press heads are raised and the branding shuttle moves the branding presses back upstream to meet up with additional baking pans to brand additional bakery goods.

In illustrative embodiments, a metering conveyor properly meters four baking pans in a staging area. Branding shuttle moves the branding presses upstream so that they are aligned with the four baking pans in the staging area. Once aligned, the baking pans and the branding presses move together downstream along the branding conveyor while the branding press heads are lowered onto the bakery goods in the baking pans for a preset dwell time. Once the dwell time is completed, the branding press heads are raised up and the branding presses are again shuttled back upstream to pair up with another four baking pans that have been properly aligned by the metering conveyor. Branding conveyor speeds up the bread pans to make up for any time lost on the metering conveyor.

These and other features of the present disclosure will become more apparent from the following description of the illustrative embodiments.

### BRIEF DESCRIPTION OF THE DRAWINGS

FIG. 1 is a perspective view of a commercial baking process that includes a high volume continuous branding system of the present disclosure;

FIG. 2 is a perspective view of the commercial baking process of claim 1;

FIG. 3 is a perspective view of the high volume continuous branding system illustrating baked goods entering the branding station at a first end upstream from the branding station and branded baked goods exiting the branding station downstream from the branding station;

FIG. 4 is a perspective view of the branding system illustrating branded baked goods exiting from the branding station;

FIG. 5 is a top view of the branding system illustrating baked goods entering and exiting the branding station;

FIG. 6 is an end view of the branding system showing the branding press positioned above the baked goods that are riding on a conveyor beneath the branding presses;

FIG. 7 is a perspective view of a portion of the branding station illustrating four branding presses positioned over bakery pans that contain baked goods to be branded. The four branding presses are configured to be conveyed by use of a gear rack and motor so that the branding presses remain aligned with the bakery pans being conveyed below the branding presses. Branding press heads are moved downward toward bakery pans by use of servo motors;

FIG. 8 is a another perspective view of the branding station;

FIG. 9 is another perspective view of the branding station illustrating several of the branding presses positioned over bakery pans with other bakery pans in que waiting for branding;

FIG. 10 is another perspective view of the branding station take from a top side showing the four branding presses and four servo motors used to lower the branding press heads on to the goods in the baking pans;

FIG. 11 is another perspective view showing one of the four press heads from the branding press removed to show the baked goods and baking pan positioned beneath;

FIG. 12 is a perspective view of baked goods that have been branded;

FIG. 13 is a perspective view of a portion of a branding press plate used to brand the baked goods;

FIG. 14 is a perspective view of the branding press heads of the branding presses showing the branding dies that can be slide out from branding die holders of the branding press heads so that other images, wording, or symbols can be exchanged for other branding jobs, the branding die holders include “T” shaped slots that accept corresponding ribs formed on the branding dies;

FIG. 15 is a top perspective view showing the branding press shuttle that moves upstream and downstream along the branding conveyor to match up with baking pans below;

FIG. 16 is another top perspective view illustrating the branding press shuttle that shows three of the four branders and the servo motors that cause downward movement of the branding press plates to brand the food items;

FIG. 17 is another perspective view of the branding shuttle showing the gear racks, drive gears and drive motor that causes movement of the branding shuttle along the branding conveyor;

FIG. 18 is a perspective view of another branding press plate used to brand the baked goods; and

FIG. 19 is a perspective view of a stack of baking pan.

### DETAILED DESCRIPTION

For the purposes of promoting an understanding of the principles of the disclosure, reference will now be made to a number of illustrative embodiments illustrated in the drawings and specific language will be used to describe the same.

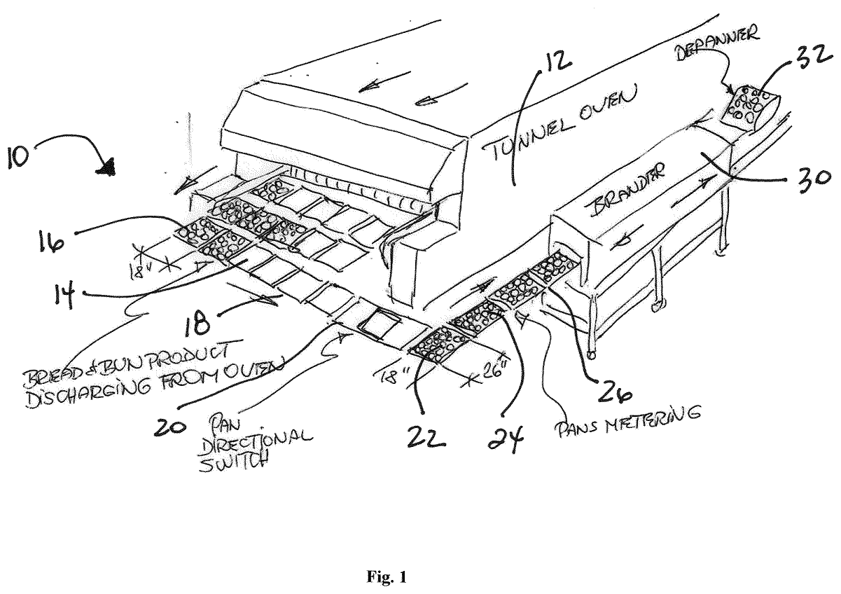

A high volume branding system 10 is shown in FIG. 1. The high volume branding system 10 is part of a commercial baking process. The branding system is integrated into a commercial baking process that includes a tunnel oven 12. Rows of baking pans 14 containing individual baked goods 16 exit tunnel oven 12 and get transferred onto a cross conveyor 18. Each pan 14 typically includes twenty four buns or other food products in each pan. While twenty four baked goods are preferred, the baking pans 14 can be designed to hold various amounts of goods. Pans 14 includes twenty four recesses to hold the baked goods and can include a row of six recesses by four recesses for twenty four recesses. Pans 14 include a length direction and a width direction. The pans 14, in one embodiment, include four recesses in the width direction and six recesses in the length direction. While a 4×6 recessed pan is preferred, other pan configurations can be used with varying numbers of recesses such as 3×6 or 4×5.

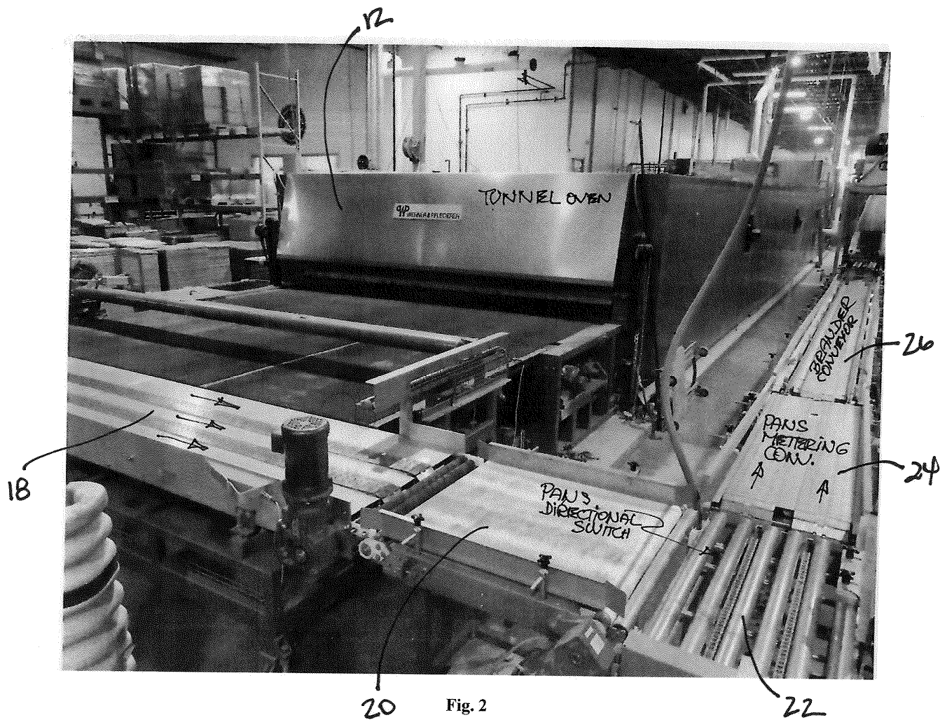

Cross conveyor 18 transfer pans 14 onto a pan speed up conveyor 20, as shown in FIGS. 1 and 2. Pan speed up conveyor 20 conveys pans 14 in the width direction where pan separation is achieved with respect to the pans 14 exiting the tunnel oven 12. Pans 14 are conveyed by the pan speed up conveyor 20 in the width direction to the pan directional switch conveyor 22. Pan directional switch conveyor 22 reorients the pans 14 so that they are conveyed in the length direction instead of the width direction.

Pan directional switch conveyor 22 conveys the pans 14 in the length direction to the pans metering conveyor 24, which presents four pans 14 to a branding conveyor 26, as shown in FIGS. 1 and 2. Pans metering conveyor 24 conveys four pans 14 to the pans metering conveyor 24. Once on the metering conveyor 24, four pans 14, in spaced orientation, will move under four branding presses 28 at the branding station 30. At this point, the pans metering conveyor 24 momentarily stops with four pans 14 to allow for the branding process to be initiated.

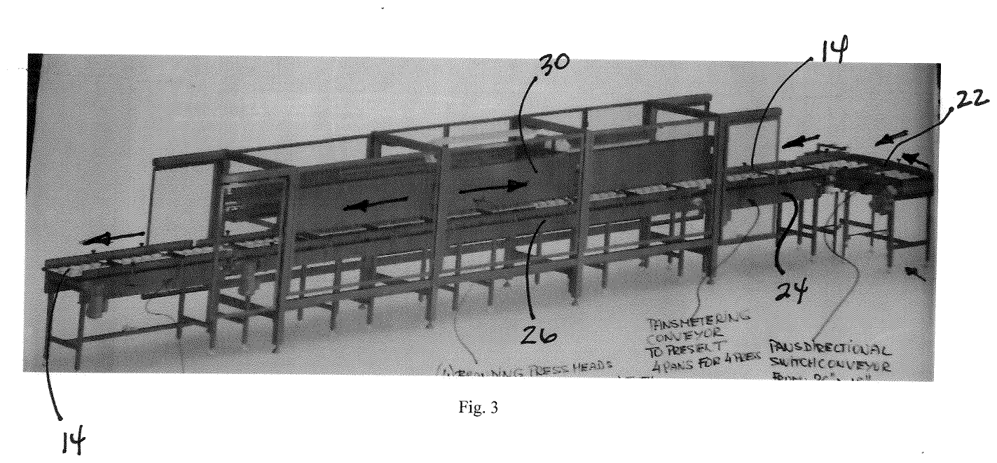

The metering conveyor 24 moves the pans 14 intermittently on the metering conveyor 24 onto the branding conveyor 26, as shown in FIG. 3. The intermittent pan movement of the metering conveyor 24 is controlled by a timer. The branding conveyor 26 includes spring-loaded pan pushers/aligners that are used to adjust the position of the pans 14 on the branding conveyor 26 to ensure proper placement of the pans 14 under the branding presses 28 so that the images applied by the branding presses 28 are properly centered on the items to be branded.

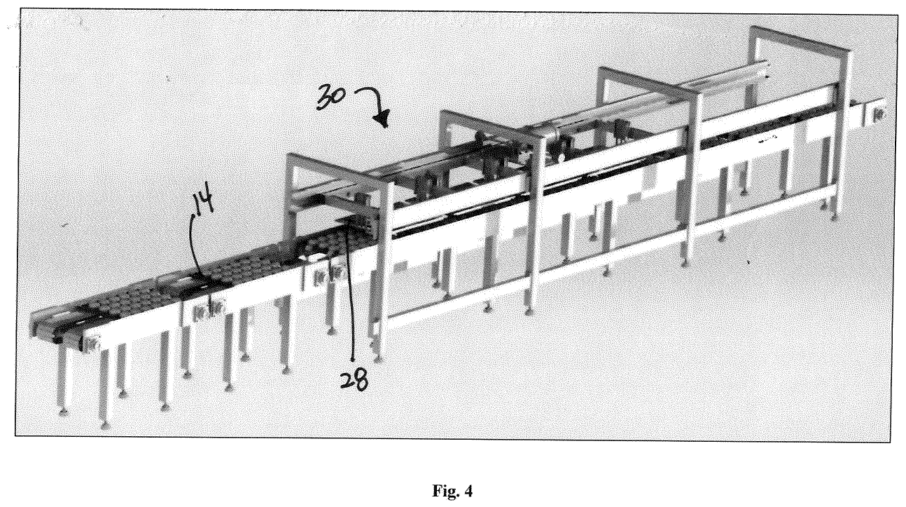

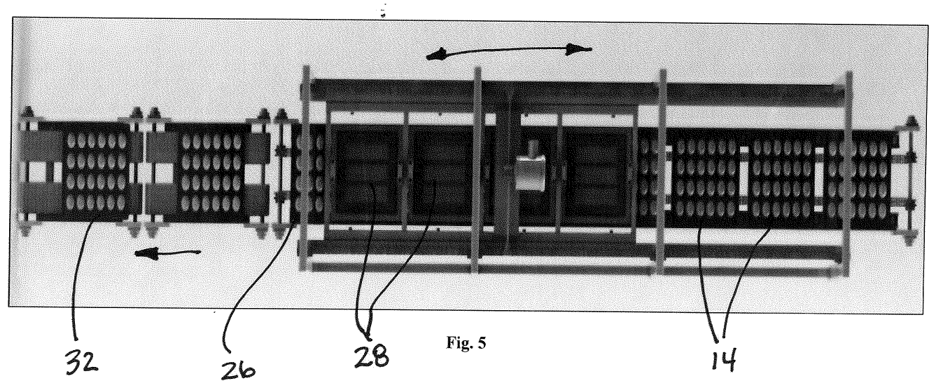

The pan pushers/aligners capture each pan 14 and move it forward one pan length intermittently until the four pans 14 are in the que on the branding conveyor 26, as shown in FIG. 3. As the four pans 14 load and group into the branding conveyor 26, the four branding presses 28 shuttle back upstream over the four pans 14 in que and the servo driven branding presses 28 send down branding press heads to brand the product, as shown in FIGS. 4 and 5. Together the four branding presses 28 shuttle along with the four pans 14 and move forward along the branding conveyor 26 at pre-adjusted speed during the brand burning cycle. Once baked goods 16 are branded, the pans 14 are shuttled downstream on depanner machine 32.

Branding station 30 is a shuttle design that shuttles the branding presses 28 back and forth. Four branding presses 28 go over the four pans 14, each containing twenty four buns. Servo motors vertically move branding press heads of branding presses 28 vertically downward and make contact with all ninety six buns simultaneously to start branding. The four pans 14 again begin to move along branding conveyor 26 along with the four branding presses 28 so that the pans 14 and branding presses 28 are moving in unison.

Branding presses 28 are electrically heated so that the images of the branding presses 28 are burned onto the buns located in the pans 14. Branding presses 28 move forward together downstream with pans 14 for a branding cycle or dwell time of approximately seven seconds. After the branding cycle is over, the four branding press heads of the branding presses 28 are lifted up vertically by the servo motors and the branding presses 28 are moved upstream to the start of the branding conveyor 26 to align with four new pans 14 and the branding cycle starts over. The branding cycle is continuous and the pans move through the branding station 30 nonstop.

The branding presses 28 include electric heaters, which heat up the branding press head plates and dies. By PLC controls, the four branding press heads of the branding presses 28, operated by servo motors, lower down on to the top of the hamburger buns and gently press and burn the brand image into the buns, in one example. A sample image that could be branded includes the logo from the Chicago Cubs baseball team, for example. After a preset/preprogrammed time, the branding press heads of the branding presses 28 lift up while the branding conveyor 26 continues to convey the four pans 14 onward to a depanner machine 32, which is used to remove the buns from the pans 14 via suction or other means.

The four pans 14 together with branding presses 28 shuttle forward to complete the branding cycle time and the branding press heads of the branding presses 28 raise up off the now branded product and the pans 14 continue to depanner. The branding cycle repeats itself by the branding presses 28 moving upstream to align with another four pans 14. The motion/branding cycle continues without interruption to the overall baking operation and is continuous. The four branding presses 28 shuttle back to pick up the next four pans 14 with products repeating the continuous cycle. Any time lost in the metering conveyor 24 is made up by the speed of the branding conveyor 26.

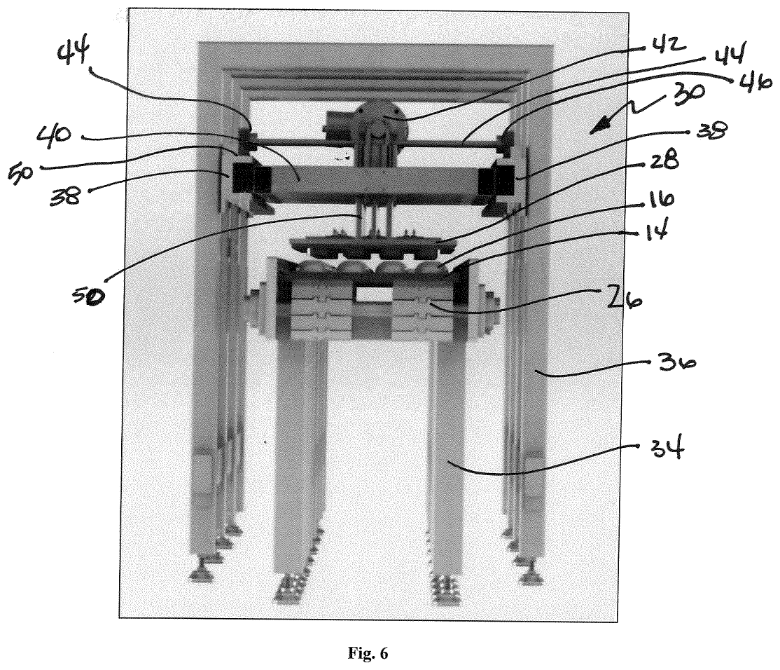

FIG. 6 illustrates an end view of the branding station 30. Branding conveyor 26 is supported by frame members 34. Branding conveyor 26 conveys pans 14 and baked goods 16 in a downstream direction. At the same time, branding station 30 shuttles branding presses 28 along with pans 14. Branding station 30 includes frame 36 that supports track 38 that allows branding shuttle 40 to move upstream and downstream. Shuttle motor 42 rotates shaft 44 and gears 46 on gear rack 48 to move shuttle 40. Branding presses 28 are suspended above pans 14 by arms 50.

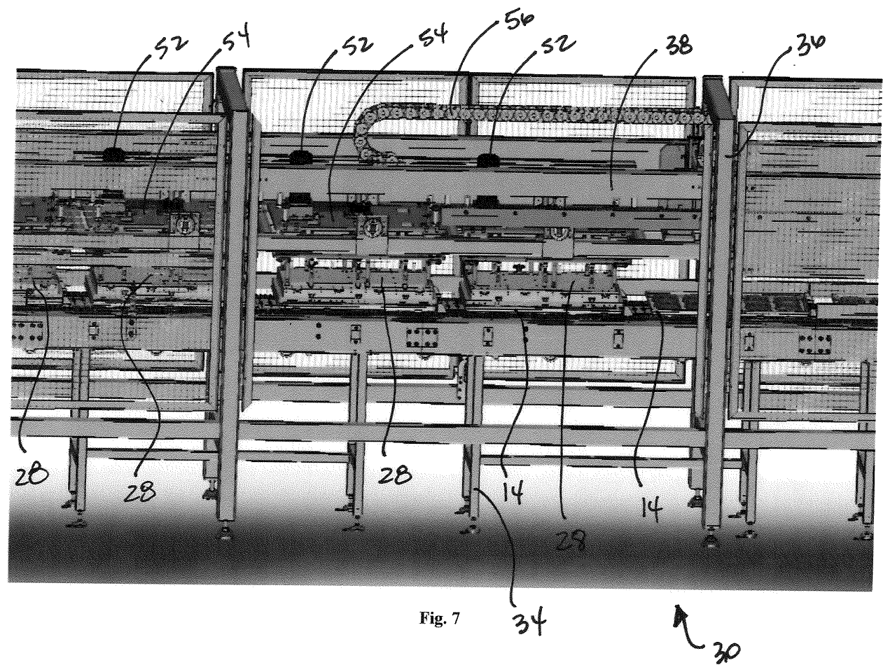

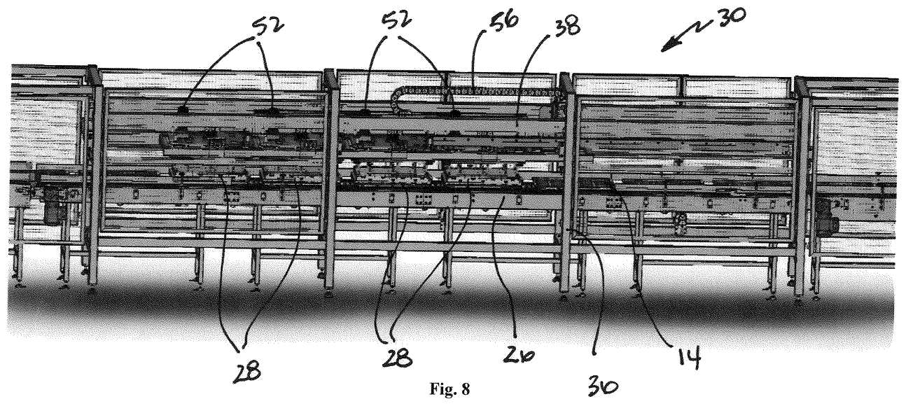

FIGS. 7 and 8 are side perspective views of branding station 30 illustrating four branding presses 28 that are independently controlled in the vertical direction by servo motors 52. Servo motors 52 are coupled to top plates 54, which are shuttled along track 38. Cable track 56 is used to secure the wiring for the servo motors 52 and heaters used to heat branding presses 28. Top plates 54 are configured to move in unison along with branding conveyor 26. Branding presses 28 are configured to be aligned with pans 14 so that branding is properly applied to baked goods 16.

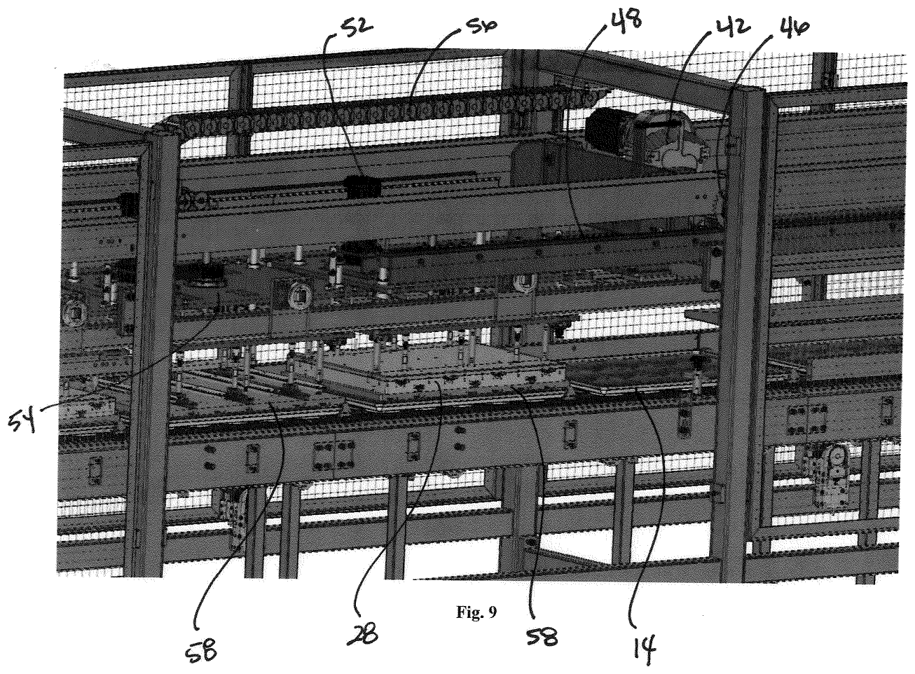

FIG. 9 illustrates an enlarged perspective view of branding station 30 illustrating branding presses 28 including branding plates 58. Branding plates are removably coupled to branding presses 28 so that branding plates 58 can be swapped out for plates with different imprint patterns. Branding plates 58 come into contact with baked goods 16 in pans 14. Branding presses 28 are connected to top plates 54 by arms 50. Heating elements are positioned in branding press to heat branding plates 58 so that they are hot enough to brand baked goods 16.

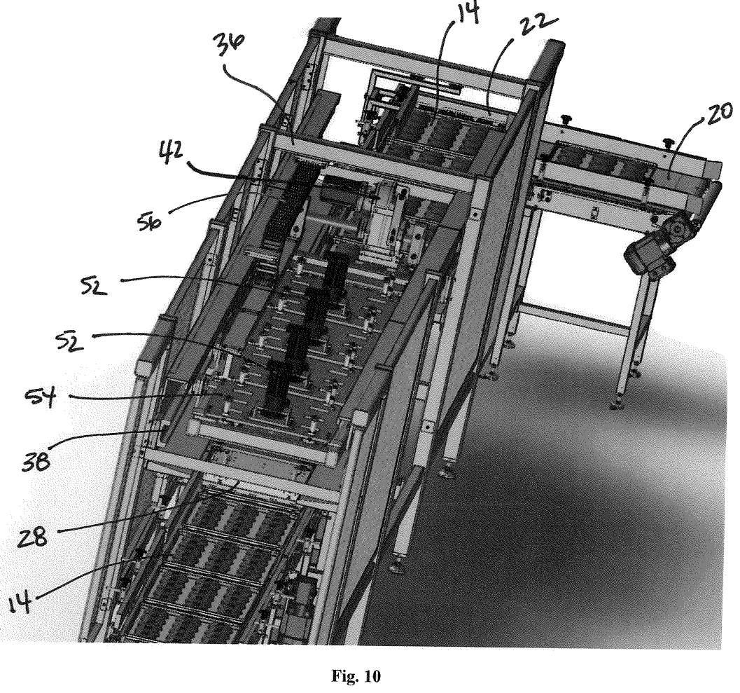

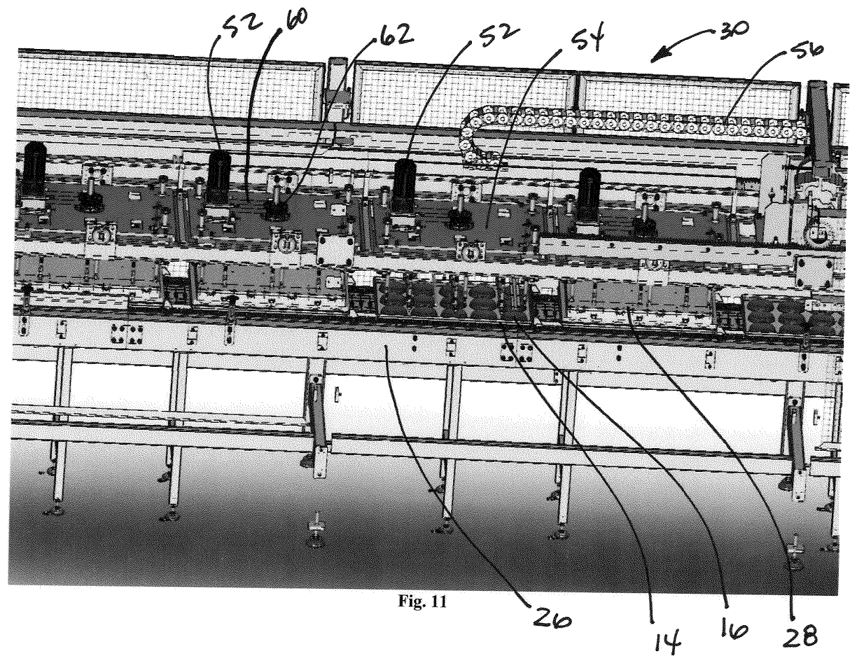

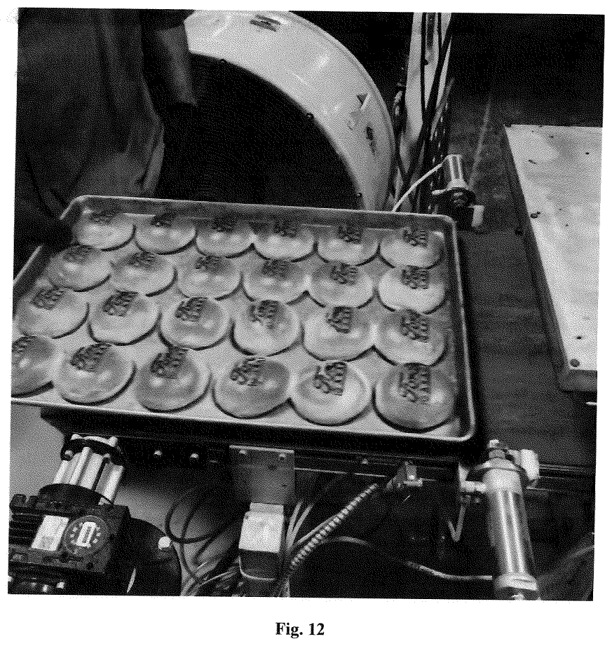

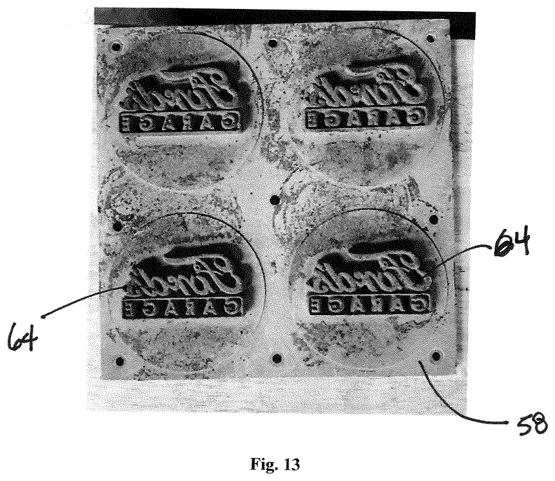

FIG. 10 is a perspective top view of branding station 30 showing top plates 54 that move in unison by use of shuttle motor 42. Each top plate 54 includes a servo motor 52 that is used to raise and lower the branding presses 28 onto baked goods 16 in pans 14. Top plates 54 are shuttled along track 38 at the same rate as the branding conveyor 26 so that branding press 28 can make contact with pans 14. FIG. 11 is a perspective view of the branding station 30 with portions removed to show the four top plates 54, each having a servo motor 52 that includes a drive belt 60 that drives a pulley 62 in a first direction to lower the branding press 28 and in a second direction to raise branding press 28. FIG. 12 illustrates a pan 14 containing baked goods 16 after they have been branded by passing through the branding station 30. FIG. 13 is an illustrative example of a branding plate 58 that includes branding indicia 64 that is to be transferred onto the baked goods.

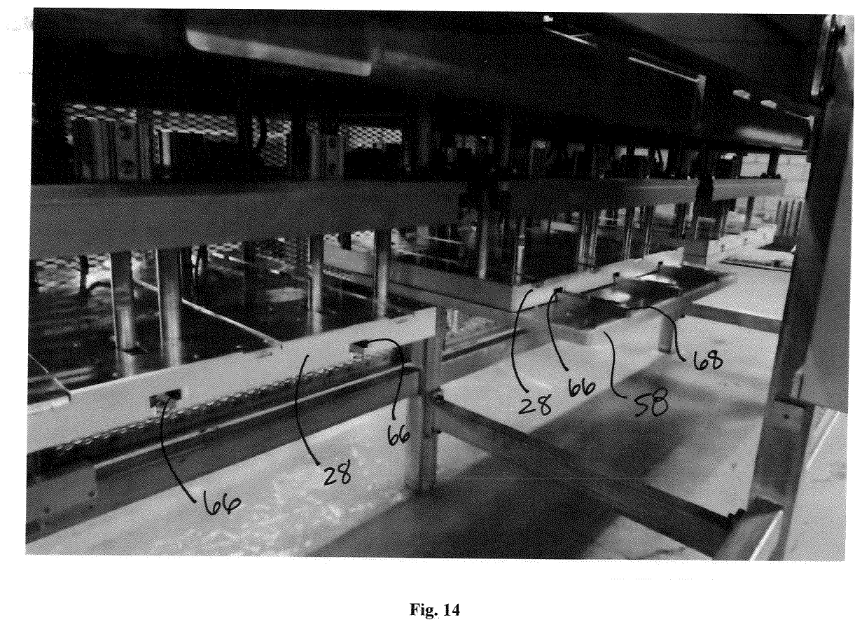

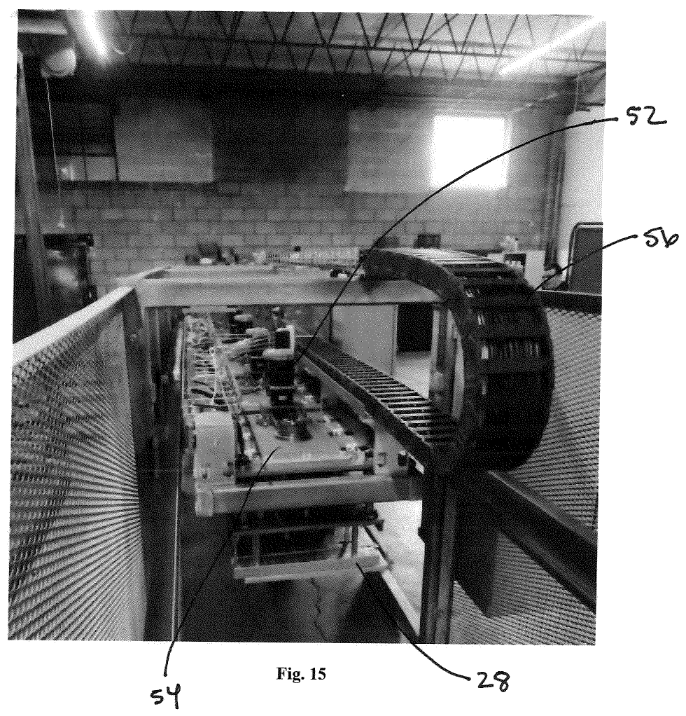

FIG. 14 is a perspective view of a pair of branding presses 28. Branding presses include a pair of slots 66. Branding plates 58 include a series of “T” shaped members 68 that are configured to slide into slots 66 to secure branding plates 58 to branding presses 28. This arrangement allows for a user to quickly switch out branding plates 58 for ones with different indicia 64. FIG. 15 illustrates the top plates 54 and servo motors 52 that are used to drive branding presses 28 downward toward the pans 14.

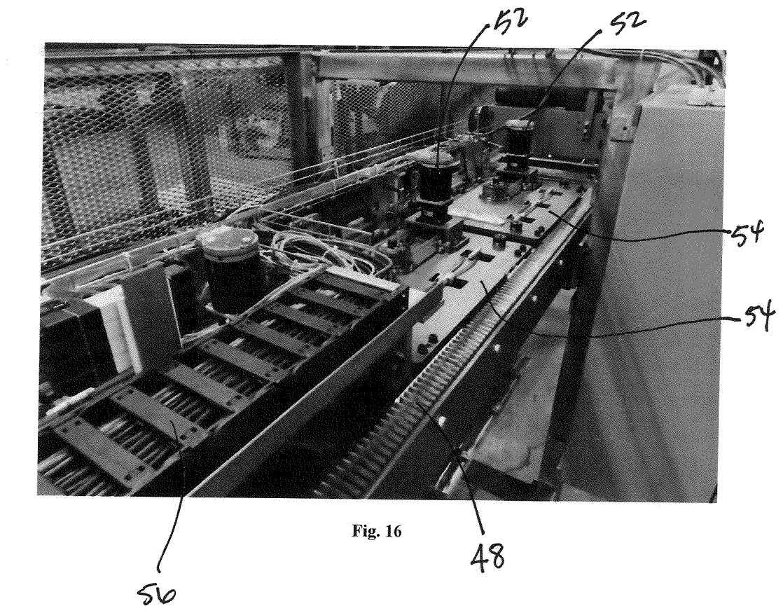

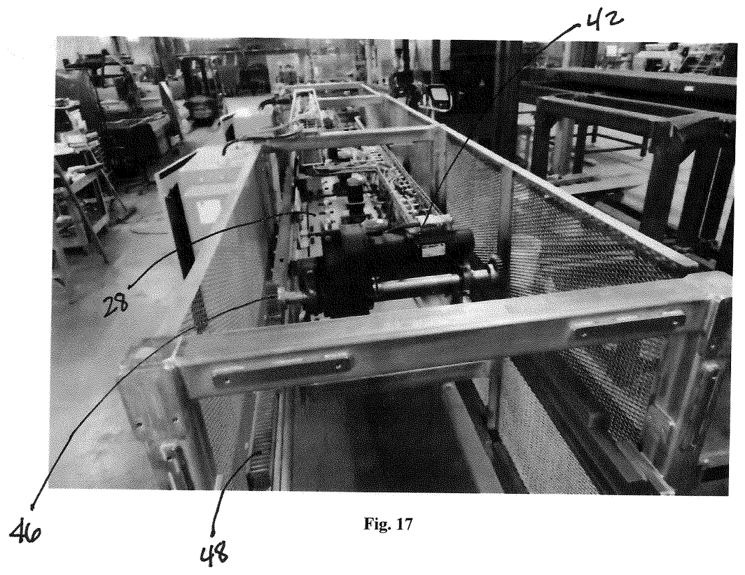

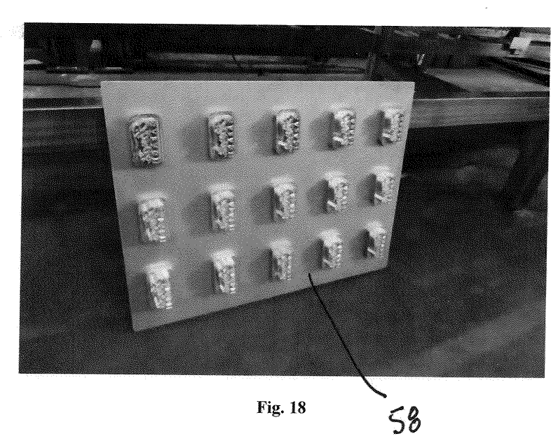

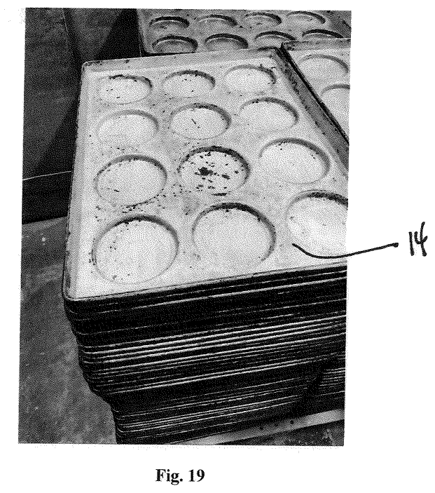

FIG. 16 shows the gear track 48 that is used by the shuttle motor 42 to shuttle the branding presses 28 along with the branding conveyor 26 so that the branding presses 28 can be aligned with the trays 14 and to provide enough dwell time so that the branding plates 58 can adequately burn the indicia into the baked goods 16. After the indicia is added to the baked goods 16, the branding plates 58 and branding presses 28 are raised upward and the branding presses 28 and branding plates 58 are shuttled back upstream to align with the next set of pans 14 that are in need of branding. With the present arrangement, branding occurs while the pans 14 and baked goods 16 are continuously being conveyed, which results in branding of product without any significant reduction in line speed. FIG. 17 illustrates the shuttle motor 42 used to shuttle the branding presses 28 along gear rack 48. FIGS. 18 and 19 illustrate a branding plate 58 and pans 14 used in the process.

In use, after the pans with baked goods leave the tunnel oven 12, the pans 14 are moved over to the metering conveyor 24. The metering conveyor 24 meters four pans 14 onto the branding conveyor 26. The four pans 14 are conveyed downstream along the branding conveyor 26. While the pans 14 are moving, the branding station 30 aligns the four branding presses 28 with the four pans 14 by moving the shuttle 40 along the gear rack 48 by use of the shuttle motor 42. The shuttle motor 42 is preferably a servo motor to allow for exacting position of the shuttle with respect to the pans 14.

Shuttle 40 moves branding presses 28 and branding plates 58 along with the pans 14 as they convey down the branding conveyor 26. Servo motors 52 then rotate to cause a threaded rod to move the branding presses 28 and branding plates 58 downward so that the branding plates 58 can brand the baked goods 16. Branding plates 58 are electrically heated by heating elements to a temperature that will leave a good impression on the baked goods in about 5 to 15 seconds of contact time between the branding plates 58 and the baked goods 16.

Once the impression is left on the baked goods, the branding plates 58 are raised by the servo motors 52 and the shuttle 40 is moved upstream back to the start of the branding conveyor 26 and aligned with the next four pans of baked goods. While four pans in the illustrative embodiments, it is contemplated that four or less or four or more pans could be used as needed.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A high volume branding system for branding baked goods arranged in pans comprising:
a branding conveyor for receiving the baked goods in the pans and conveying the pans downstream;
a branding station positioned above the branding conveyor, the branding station having a shuttle provided with a branding press, the shuttle being configured to travel downstream with the branding conveyor in a first direction and upstream in a second direction;
the shuttle configured to align the branding press with at least one of the pans on the branding conveyor while the pan is moving downstream along the branding conveyor;
the branding press including a branding plate that is heated and lowered with the branding press onto the baked goods in the pan while the shuttle is moving downstream along with the pan and branding conveyor to brand indicia onto the baked goods;
wherein when the indicia is branded onto the baked goods, the branding press and branding plate are raised and the shuttle is moved in the second direction to align the branding press with another one of the pans on the branding conveyor.

2. The high volume branding system of claim 1, wherein the shuttle includes a series of branding presses.

3. The high volume branding system of claim 2, wherein each branding press includes a branding plate that includes indicia that is branded onto the baked goods when the branding plate is heated and brought into contact with the baked goods.

4. The high volume branding system of claim 2, wherein the shuttle includes at least one motor that is used to rise and lower the series of branding presses from a first position to a second position and from the second position to the first position.

5. The high volume branding system of claim 1, wherein the shuttle is moved along a track.

6. The high volume branding system of claim 5, wherein the shuttle includes a shuttle motor that drives a gear.

7. The high volume branding system of claim 6, wherein the branding station includes a gear rack and the shuttle motor drives the gear along the gear rack to move the shuttle in the upstream and downstream directions.

8. A high volume branding system for branding baked goods arranged in pans comprising:
a branding conveyor for receiving the baked goods in the pans and conveying the pans downstream;
a branding station positioned above the branding conveyor, the branding station having a shuttle provided with a plurality of branding presses, the shuttle being configured to travel downstream with the branding conveyor in a first direction and upstream in a second direction;
the shuttle configured to align the branding presses with a corresponding number of pans located on the branding conveyor while the pans are moving downstream along the branding conveyor;
the branding presses each including a branding plate that is heated and lowered with the branding presses onto the baked goods in the pans while the shuttle is moving downstream along with the pans and branding conveyor to brand indicia onto the baked goods;
wherein when the indicia is branded onto the baked goods, the branding presses and branding plates are raised and the shuttle is moved in the second direction to align the branding presses and branding plates with another number of pans on the branding conveyor.

9. The high volume branding system of claim 8, wherein the shuttle includes at least one motor that is used to rise and lower the branding presses from a first position to a second position and from the second position to the first position.

10. The high volume branding system of claim 8, wherein the shuttle is moved along a track.

11. The high volume branding system of claim 11, wherein the shuttle includes a shuttle motor that drives a gear.

12. The high volume branding system of claim 12, wherein the branding station includes a gear rack and the shuttle motor drives the gear along the gear rack to move the shuttle in the upstream and downstream directions.

13. A high volume branding system for branding baked goods arranged in pans comprising:
a metering conveyor for receiving the baked goods in the pans and conveying the pans downstream;
a branding conveyor downstream from the metering conveyor, the branding conveyor configured to receive the pans from the metering conveyor and conveying the pans downstream;
a branding station having a shuttle provided with a plurality of branding presses, the shuttle being configured to travel downstream with the branding conveyor in a first direction and upstream against the direction of the branding conveyor in a second direction;
the shuttle configured to align the branding presses with a corresponding number of pans located on the branding conveyor while the pans are moving downstream along the branding conveyor;
the branding presses are configured to be lowered onto the baked goods in the pans while the shuttle is moving downstream in sync with the pans and branding conveyor to apply indicia onto the baked goods;
wherein when the indicia is branded onto the baked goods, the branding presses are raised and the shuttle is moved in the second direction to align the branding presses with another number of pans on the branding conveyor.

15. The high volume branding system of claim 14, wherein the shuttle includes at least one motor that is used to rise and lower the branding presses from a first position to a second position and from the second position to the first position.

16. The high volume branding system of claim 8, wherein the shuttle is moved along a track.

17. The high volume branding system of claim 16, wherein the shuttle includes a shuttle motor that drives a gear.

18. The high volume branding system of claim 17, wherein the branding station includes a gear rack and the shuttle motor drives the gear along the gear rack to move the shuttle in the upstream and downstream directions.

19. The high volume branding system of claim 14, wherein each branding press includes a branding plate that includes indicia that is applied onto the baked goods when the branding plate is brought into contact with the baked goods.

20. The high volume branding system of claim 19, wherein the branding plates are heated so that the indicia is branded onto the baked goods when the branding plates are brought into contact with the baked goods.
